(19) United States
(12) Patent Application Publication
(10) Pub. No.: US 2023/0339609 A1
(43) Pub. Date: Oct. 26, 2023

(54) AUTONOMOUS DRONE COMPONENT INTEGRATION

(71) Applicant: Blue Cloak LLC, Sterling, VA (US)

(72) Inventors: Vinson Cornejo, Sterling, VA (US); Nhan Nguyen, Sterling, VA (US)

(73) Assignee: Blue Cloak LLC, Sterling, VA (US)

(21) Appl. No.: 17/729,201

(22) Filed: Apr. 26, 2022

(51) Int. Cl. B64C 39/02; B64D 47/00; G05D 1/10; H01Q 1/28; H01Q 5/307

(52) U.S. Cl. CPC B64C 39/024; B64D 47/00; G05D 1/101; H01Q 1/28; H01Q 5/307; B64C 2201/141; B64C 2201/128; B64C 2201/127; B64C 2201/122

(57) ABSTRACT

The present invention includes a drone system and kit with a modular hold. The drone, or its hold, can low-mount antennae such that the drone system lands on the antennae (or booms dimensioned to be similar thereto). Because the holds are dimensionally similar, multiple holds can be prepared, each with their own specific electronic payload, for a quick change that results in efficient utilization of proceeds.

### FIELD OF THE INVENTION

The present invention relates to the field of aviation and more specifically to the field of autonomous flight mechanics and systems.

### BACKGROUND

Most commercial drones are capable of carrying a payload. Many drones that are popular among recreational flying pilots can carry around 3 to 5 lb (2.2 kg) of payload. Most common payloads have been cameras, used now for taking aerial photography. Other payload types on drones have been outfitted with flood lights or speaker systems used for firefighting, search and rescue, or site inspections. The present application is focused on a payload chassis dedicated to cyber security equipment for cyber focused efforts.

### SUMMARY

This lightweight system ideally includes a drone payload chassis to carry single board computers and provides the utilization of connecting external Sub-Miniature Version ‘A’ (“SMA”) compatible wireless antennas, enabling but not limited to, radiofrequency spectrum missions. The Omni-directional wireless antennae also function as landing gear. The frame is dual purpose and each function is described as best possible below:

The payload fuselage accepts a hold that supports carrying single board computers. The frame weight was designed through three-dimensional modeling and utilizes three-dimensional printing to influence shaping to successfully allow the frame to reduce the amount of material used for the chassis to remain lightweight, provide passive cooling and be aerodynamic.

A second feature pertains to the payload hold's four leg hole mounts. Each mount allows the pass through of an external SMA screw-on wifi antenna. From within the chassis, each antenna's SMA connectors are wired to be connected to small single board SMA receiver to provide wireless radiofrequency support. Outside of the fuselage, the antennae can serve as landing gear.

Accordingly, the present invention is directed to drone construction and processes of surveillance with drones. The present invention includes a drone body having a propulsion system. A fuselage on the drone body has an electronic controller with persistent memory and an arithmetic logic unit (“ALU”) and an electronic payload. There is an antenna network positioned external to said fuselage, downwardly extending into an orientation adapted exclusively to stabilize the drone body in a balanced, immobile state on a predetermined landing surface. The antenna is also adapted to transmit and receive electromagnetic signals.

The present invention further includes a process for autonomous drone surveillance of a target. The process includes releasing a flying autonomous drone in the vicinity of a surveillance target in range to surveil the target with an electronic payload carried by the drone. Information is transmitted from the electronic payload via a drone antenna network to a ground station. The drone is then landed on a landing surface, and stabilization for the drone in the landing state is maintained supportive surface contact with the antenna network.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a plan view of the system of the present invention.

FIG. 2 is a plan view of the kit of the present invention.

FIG. 3 is a perspective view of the removable hold of the present invention.

FIG. 4 is a top plan view of the removable hold of the present invention.

FIG. 5 is a rear plan view of the removable hold of the present invention.

FIG. 6 is a side perspective view of the removable hold of the present invention.

FIG. 7 is an upper perspective view of the removable hold of the present invention.

FIG. 8 is a lower perspective view of the removable hold of the present invention.

FIG. 9 is an enhanced view of the removable hold of the present invention.

FIG. 10 is a upper perspective view of the removable hold of the present invention taken along line AA from FIG. 8.

FIG. 11 is a lower perspective view of the removable hold of the present invention taken along line BB from FIG. 9.

FIG. 12 is a view of the process of the present invention.

### DETAILED DESCRIPTION

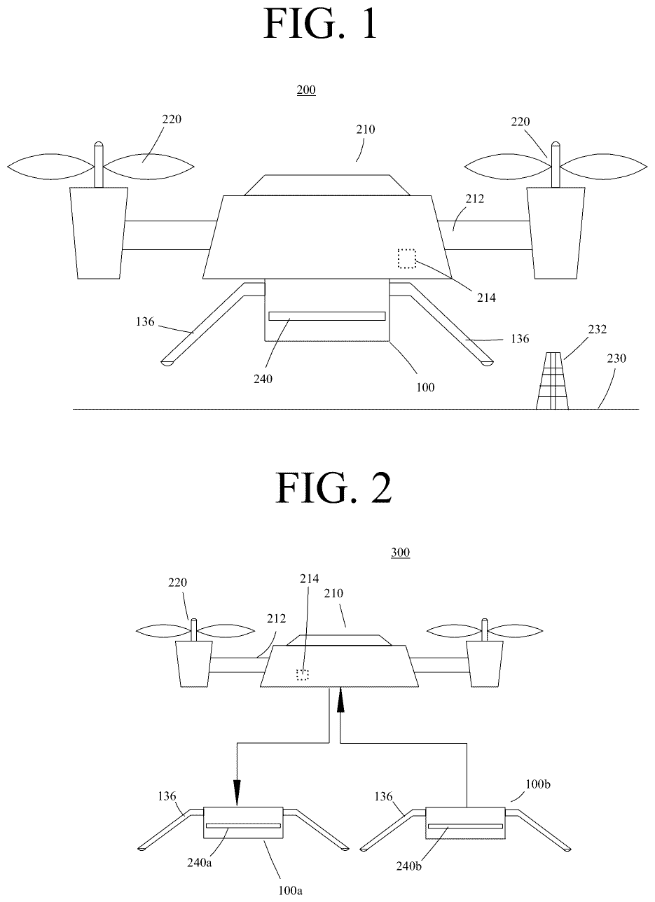

Referring first to FIGS. 1-2, the present invention includes a drone system 200 and kit 300 centered around a hold 100. Unmanned aerial vehicle (“UAV”) technology covers everything concerning autonomous flight from the aerodynamics of the drone, materials in the manufacture of the physical UAV, to the controller (e.g., circuit boards, chipset and software) which is the brains of the UAV. A typical UAV is made of light composite materials to reduce weight and increase maneuverability. This composite material strength allows specially-purposed drones to cruise at extremely high altitudes. UAV are equipped with different state of the art technology such as infrared cameras, GPS and laser (consumer, commercial and military UAV). Drones are controlled by, and/or are communication with, remote ground control systems (GSC) and also referred to as a ground station 232.

UAV systems 200 include propulsion system 220 (motors, electronic speed controllers and propellers) that move the UAV into the air and to fly in any direction or hover. On a quadcopter, the motors and propellers work in pairs with two motors/propellers rotating clockwise and two motors rotating counterclockwise. They receive data from the flight controller and the electronic speed controllers (ESC) on the drone motor direction to either fly or hover. The Electronic Speed Controllers signal to the drone motors information on speed, braking and also provide monitoring and fault tolerance on the drone motors.

The UAV system 200 includes a drone body 210 composed of a drone fuselage 212 that supports the propulsion system 220 and a cargo hold 100. Further included in the drone body 210 is the controller 214 that can include such components, discretely or integrated into a single board, as are necessary for the control of the UVA system 200. The UAV controller 214, however, cannot be expected to have the flexibility to support the more advanced sensor arrays that are being fielded on UAV systems. Indeed, a commercial UAV platform of any quality is a significant expense, and the idea of having one drone per surveillance package is financially unsound. The present invention involves a UAV system 200, or drone, capable of utilizing a repurposeable cargo hold 100, that is also capable of quick change. As such the present invention can be described as a kit 300 for all intents and purposes to the extent that a field, or other simplistic modification, is all that is needed for a distinct surveillance mission with changed surveillance equipment.

With reference to FIG. 2, the present invention as a kit 300 includes the drone 200 of the present invention with multiple cargo holds 100a, 100b. The cargo holds 100a, 100b include similar dimensions, but more particularly similar affixation mechanisms for affixation between the cargo hold 100a, 100b and the body 210. The first cargo hold 100a can include a first surveillance package 240a that is replaced entirely with a second cargo hold 100b with a second surveillance package 240b. The current state of the art features a drone that can have surveillance equipment affixed in some fashion to its body, and if the equipment needs to be changed, then the surveillance equipment is removed and replaced with different surveillance equipment. The present invention demarcates a special location for surveillance packages 240a, 240b, a hold 100a, 100b. Furthermore, the hold 100 may be removable from the drone fuselage 214 (i.e., the drone body exclusive of the engine(s) 220). By having substantially identical holds, or at least those portions that are affixable to the fuselage permits exchangeability of a surveillance package 240a by manipulating a second hold 100b with its own surveillance package 240b rather than directly manipulating the surveillance equipment. This indirect form of quick-change is a primary basis of invention for the present invention and disclosure.

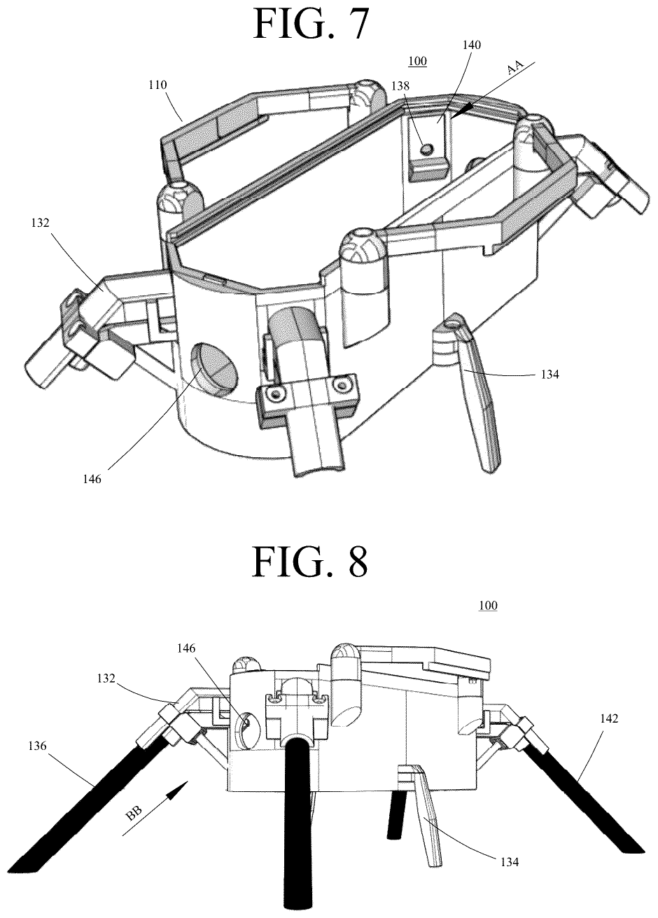

Returning to FIGS. 1-2, this lightweight system is a drone payload chassis to carry single board computers 214 and provides the utilization of connecting external SMA compatible wireless antennas 136 enabling but not limited to RF spectrum missions. The Omni-directional wireless antennas also function as landing gear. The frame is dual purpose and each function is described herein. The hold interior frame supports carrying single board computers, which can be a constituent of the surveillance equipment 240. The frame weight was designed through three-dimensional modeling and utilizes three-dimensional printing to influence shaping. Allowing the frame to reduce the amount of material, see e.g., FIG. 7, used for the chassis to remain lightweight, provide passive cooling and be aerodynamic.

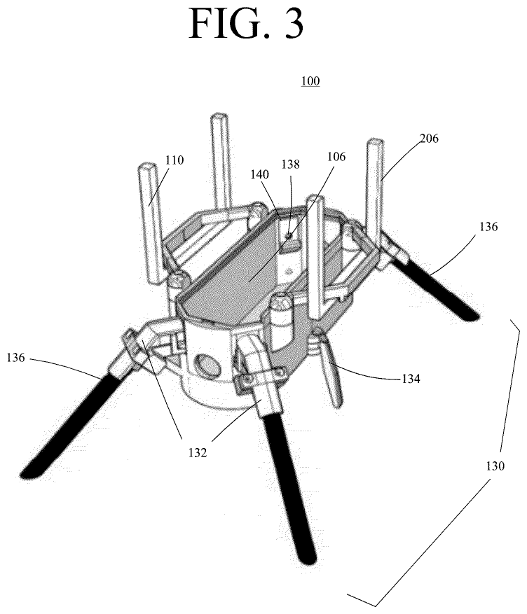

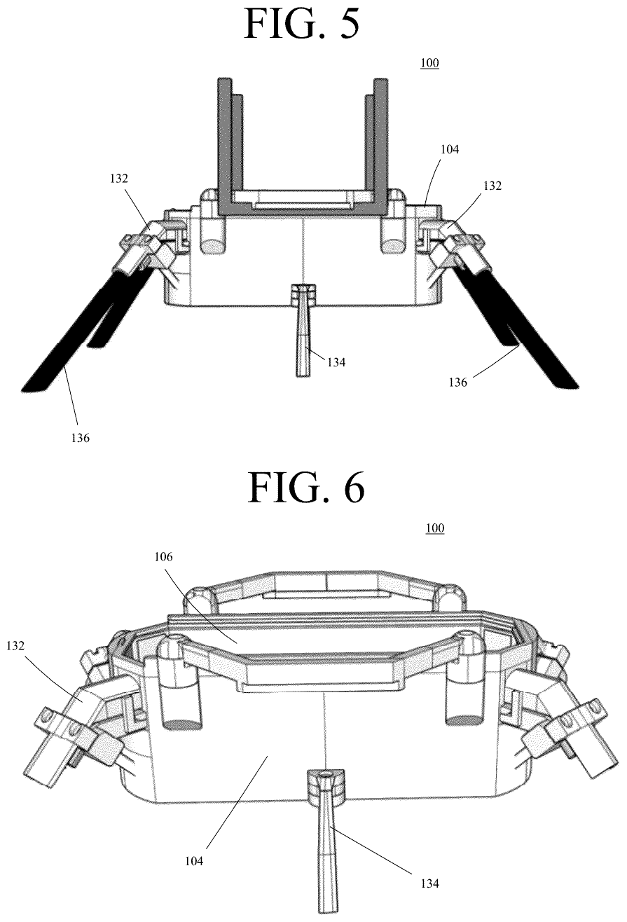

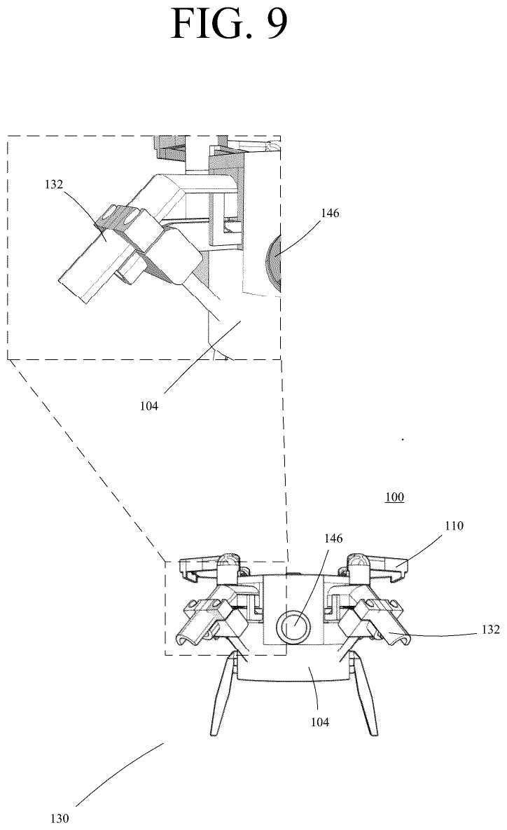

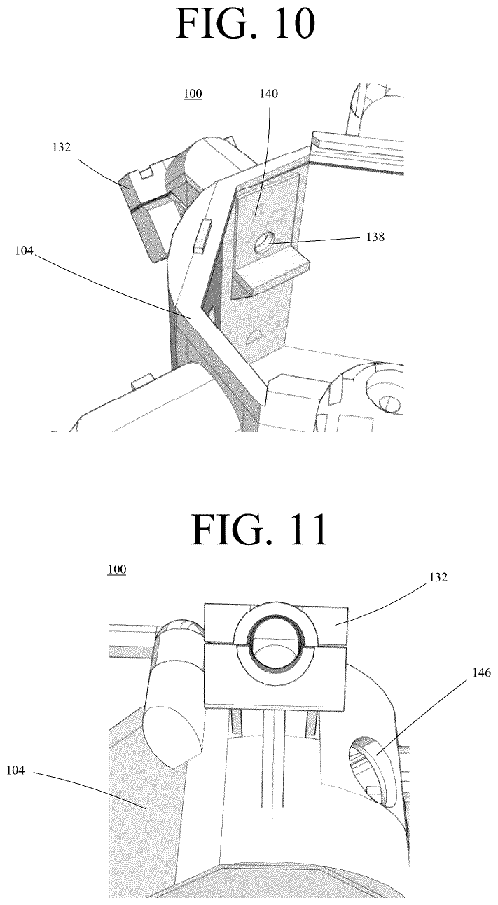

Turning now to FIGS. 3-11, a second basis of invention pertains to the payload hold's four leg hole mounts 132. Each mount 132 allows the pass through of an external SMA screw on a wife antenna 136. From within the hold 100, each antenna's SMA connectors are wired to be connected to small single board SMA to provide wireless RF support. Outside of the hold 100, the antennas 136 serve as landing gear. The hold allows for different length antennas to be connected, while the payload hold may have universal mounting brackets along the side and lid that is flat, allowing it to be carried below the fuselage of payload capable drones.

With reference to FIG. 3, the present invention includes an antennae network 130 that is composed of one or more antennae 136. Here, a significant aspect of the present invention is the reconfiguration of the components of the drone in order to eliminate excess body weight while enhancing functionality. Dedicated single purpose, landing gear, as uncovered by the present invention, need not be a feature of the present invention. Instead, structure utilized as landing gear can also serve as communications equipment. Landing structure, to serve the purpose of landing structure, needs a handful of attributes. Landing structure should either be positioned at a low, or preferably the lowest, point of the drone body. Alternatively, the landing structure can be specially configured to mate with a distinct landing platform. For example the landing structure for a drone will conventionally include a series of three or more booms protruding below the drone body. Such a configuration will allow the drone to land on generally any flat surface. Other landing structure may include a circular leg that is either complete or includes one or more separations. Generally landing structures applicable to helicopters can also be applied to drones, such that legs are concluded with a series of booms connecting the legs to form a stable, longitudinal pair of parallel structures.

Wi-Fi is a wireless networking technology that employs radio waves, or other spectra, in the range of 2.4 Ghz or 5 Ghz to provides an ultra fast network communication to various devices such as computers, mobile phones, printers, etc. Devices in a WiFi network are connected together wirelessly for the purpose of sharing resources and information. Wifi can be used to transfer files and information between devices at a very high speed. Devices like printers, scanners and other hardwares can be shared easily without the use of wires directly connecting the devices. Furthermore, Wifi networks have excellent pre-existing security measures that can be applied to a wide range of operations and processes. WiFi antennae transmit network data packets. The Wireless Router/Access Point converts these data packets to EM waves, radiated out through the transmitting antenna and the antenna in the Client device (mobile device) converts the EM waves back to electrical signals for data processing. WiFi uses a frequency of 2.4 GHz or 5 GHz. Wavelength of 2.4 GHz is nearly 12.5 cm and for 5 Ghz is 5-6 cm. As mentioned above, the antennas are designed depending up on the frequency of the signals to be transmitted/received, which means, we cannot use 2.4 GHz antenna cannot necessarily be substituted for 5 GHz antenna and vice versa. They can, however, have similar physical dimensions. Dipole WiFi Antennas are one of the most simplest type of antenna. It is also known as Half-Wave dipole antenna because its length is half the wavelength. It consist of two identical metal rods which are separately fed using two different wires or feed lines. These half wave antennas are commonly used for indoor purposes such as WiFi Routers, USB WiFi adaptors, television etc, but as discussed, they also are the preferred version of the landing antenna 136 of the present invention.

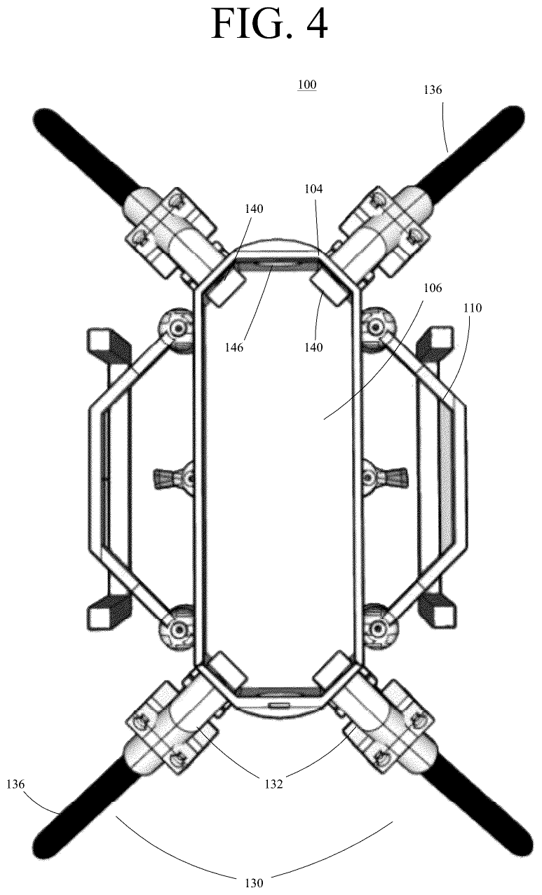

Turning now to FIGS. 4-7, the preferred hold 100 of the present invention includes a hold sidewall 104 that fits with the drone body 210 of the system 200. The hold sidewall 104 includes antenna mounts 132 that allow one or more antenna 136 or boom 142 to affix to the hold 100. Accordingly, the hold 100 can be quickly affixed or removed from the drone body 210 and the hold serves as an independent landing mechanism for the system 200. In the preferred orientation of the antenna mounts 132 and antenna/boom results in a stable orientation. For ‘stick’ shaped antenna, the preferred orientation is that of jutting table-legs, spaced symmetrically. It may be worth noting that the landing gear orientation need not result in a completely stable system, and the orientation of the landing antenna can accommodate the physical dimensions of the antenna. In certain embodiments, circular antenna may be used singly, or two or more half circles, forming part of the landing gear. For purposes of the present invention, when discussing antenna as landing gear it is meant that in its stationary resting period, the drone system 200, has at least part of its components that transmit/receive signals contacting the land surface 230.

In not all instances are the landing surfaces the ground or other flat surface. The landing surface should always be considered in relation to the antenna of the drone system and hold. In instances where the landing surface is a hook (e.g., in sea-based operations), the antenna can have hook or loop shaped (or vice versa) dimensions that allow a collision-based landing. Here, because a hook-shaped antenna could contact the loop landing surface for a landing, the landing gear can have such unorthodox landing dimensions.

Turning now to FIGS. 7-11, the hold 100 can have a sidewall 104 that defines an interior cavity 106 bearing any electronics capable of use with the present invention. The hold sidewall 104 includes means for the signaled communication with the antenna network 130. In the preferred version of the present invention, the hold sidewall 104 includes aperture 138 that allow wiring to connect electronics within the hold cavity 106 to the exteriorly positioned antenna. The aperture 138 can have any quantity or position suitable to connect internal electronics to the antenna. Furthermore, preferred embodiments include clips 140 that allow any of the antenna-wire complex to remain stationary during flight. Furthermore, movement of the clips 140 allow quick change replacement of the antenna and any wiring associated therewith. Mounts 132 can be configured with the clips 140 in order to maintain any of the components of the present invention; while the clips maintain positioning of wires, the mounts 132 can compress the antenna for the quick change of the present invention.

Other apertures can be utilized with the present invention as ventilation, for example, a wall aperture 146, which for purposes of the present invention, is simply an aperture for purpose other than the direct passage of wiring to an antenna. Other electronic equipment can utilize the wall aperture(s) 146 for purposes of ventilation or physical manipulation. An example of physical manipulation includes use of the wall aperture 146 for optical surveillance, thermal detection, or other sensors.

The present invention need not include landing that is composed solely of the antenna. In certain embodiments of the present invention, legs 134 can be positioned on the hold 100 in order to stabilize the landing of the system.

Accordingly in the present invention the hold 100 may form a removable component that is standardized and modular to effect the advantages of the present invention. Here, the hold 100 supports an electronic array 240 that is the basis of the surveillance or other electronic signal based endeavor.

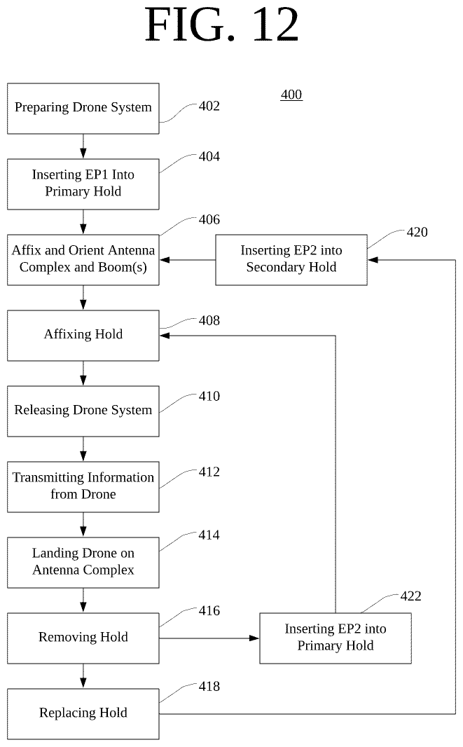

The present invention accordingly can be used in a quick-change process 400 as shown in FIG. 12. The process 400 can be used to implement any of the features of the present invention. A drone is often utilized in surveillance of distant people, objects, and features. The drone system as discussed in any of the implementations of this disclosure is prepared 402. The preparation can include any of the maintenance involved in operating a drone, such as powering the power source, lubricating components, testing signaling capacity, orienting flight components, etc. Significantly, according to the features of the present invention, a hold 100 can be prepared in which one or more electronic payloads 240 are applied to the hold, irrespective of preparations in relation to the drone. The drone 100 can be entirely self-supporting from an electronics and power perspective relative to the drone. So, in the present invention, electronic payload can include any of one or more supportive components; for example, the electronic payload 240 can include a thermal camera along with operative computing components and battery. In situations where a drone is utilized in multiple sensory capacities, a primary payload can be applied/inserted 404 to/into a primary hold. A secondary hold, having dimensions equivalent to the primary hold, can be prepared by inserting 420 a secondary electronics payload for use immediate to cessation subsequent to the use of the first electronic payload. Any number of holds and payloads can be prepared beforehand with one or more drones, although in the spirit of the present invention and its efficiency savings, it is likely that one drone body will be applied to multiple holds. As will be shown later, the affixation/removal 416 aspects of the hold may result in replacement of the electronics payload 416 rather than replacement of the hold and payload.

However, because the present invention may feature antenna in lower regions for use in the simultaneous function of landing and transmission/reception, any antenna in the antenna complex that are utilized for landing should be affixed and oriented 406 to permit stable landing. This can happen before or after the hold is affixed 408, and the difference may lay in the benefits in balancing the antenna orientations based on the symmetry and weight eccentricities of the drone. In most instances, the antenna of the system may not be wholly sufficient to support the weight of the drone and/or the hold, so in such instances legs may be oriented to stabilize the and support the drone system.

The drone with the hold is released 410 to perform such missions for which the drone and the electronic payload in its hold may be useful. Information is transmitted 412 from the drone to one or more ground stations, or is otherwise retained for later transmission. Transmission for the purposes of the present invention includes transmissions during flight from radiofrequency transmission, or storage in the electronic payload, for later physical interface with a computer storage in a third party device. The drone can then landed 414 on a landing surface, which can include a generally flat surface or any other surface adapted to physically accept one of more antenna of the antenna complex. Now that the drone is once again securely landed, the hold can be removed 416 for further quick-change operations. The first of the quick changes can include removal of the hold for replacement by insertion 422 of one electronic payload for another. Of greater interest to the present invention the secondary hold, with the secondary electronic payload, that was prepared either during the initial stages of the process, during flight, or contemporaneous to the landing of the drone, can now be replaced by insertion 420 (prior or contemporaneously) of the secondary payload into the secondary hold for replacement 418 of the primary hold. Now the drone system is free to immediately to return to surveillance or action with minimal activity.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. An autonomous flying drone comprising:
a drone body having a propulsion system;
a fuselage, on said drone body, having an electronic controller having persistent memory and an arithmetic logic unit (“ALU”) and an electronic payload; and
an antenna network: (i) positioned external to said fuselage, downwardly extending into an orientation adapted exclusively to stabilize said drone body in a balanced, immobile state on a predetermined landing surface; and (ii) adapted to transmit and receive electromagnetic signals.

2. The drone of claim 1 having antenna mounts integrated into said fuselage in an orientation adapted to maintain said immobile state.

3. The drone of claim 2 wherein said antenna network is removably affixed to said antenna mounts.

4. The drone of claim 3 wherein said antenna network includes a primary antenna for a primary signal generation/reception, and a secondary antenna for secondary signal generation/reception, at a different spectrum from said primary antenna, and wherein both said primary antenna and said secondary antenna are dimensioned to releasably affix to said antenna mounts.

5. The drone of claim 2 wherein said antenna network includes an inert artificial boom dimensioned to (i) releasably affix to said antenna mount, (ii) and maintain said immobile state.

6. The drone of claim 2 further wherein said fuselage includes a removable hold with a hold sidewall defining a cavity.

7. The drone of claim 6 wherein said hold sidewall includes a connection aperture adjacent to at least one of said antenna mounts.

8. The drone of claim 7 further comprising a primary electronic payload entity having a primary entity communication port adapted to be in signaled transmission with said antenna complex.

9. The drone of claim 8 further comprising a secondary electronic payload entity, sized similar to said primary electronic payload entity, having a second entity communication port adapted to be in signaled transmission with said antenna complex.

10. The drone of claim 2 wherein said antenna network includes a primary antenna for primary signal generation/reception, and a secondary antenna for secondary signal generation/reception, operating at a different spectrum from said primary antenna, and wherein both said primary antenna and said second antenna are dimensioned to releasably affix to said antenna mounts.

11. The drone of claim 10 wherein said antenna network includes an inert artificial boom dimensioned to (i) releasably affix to said antenna mount, (ii) and maintain said immobile state.

12. An autonomous flying drone comprising:
a drone body having a propulsion system;
a fuselage, on said drone body, having an electronic controller having persistent memory and an arithmetic logic unit (“ALU”), and a removable hold with a hold sidewall defining a cavity;
an antenna network: (i) positioned external to said hold, downwardly extending into an orientation adapted exclusively to stabilize said drone body in a balanced, immobile state on a predetermined landing surface; and (ii) adapted to transmit and receive electromagnetic signals;
a primary electronic payload entity, sized to be positioned within said hold, having a primary entity communication port adapted to be in signaled transmission with said antenna complex; and
a secondary electronic payload entity, sized similar to said primary electronic payload entity, having a second entity communication port adapted to be in signaled transmission with said antenna complex.

13. The kit of claim 12 wherein said kit includes a primary removable hold bearing said electronic payload entity and a secondary removable hold bearing said secondary electronic payload entity, and wherein said primary removable hold and said secondary removable hold include identical attachment means adapted to mate with attachment means on said fuselage.

14. The kit of claim 13 wherein said antenna network consists of a primary antenna set affixed to said primary removable hold and a secondary antenna set, operating at a different spectrum from said primary antenna, affixed to said secondary removable hold.

15. The kit of claim 12 wherein said removable hold sidewall includes said antenna network with a primary antenna for primary signal generation/reception, and a secondary antenna for secondary signal generation/reception, operating at a different spectrum from said primary antenna, and wherein both said primary antenna and said second antenna are dimensioned to releasably affix to said antenna mounts.

16. The kit of claim 15 wherein said antenna network includes an inert artificial boom dimensioned to (i) releasably affix to said antenna mount, (ii) and maintain said immobile state.

17. A process for autonomous drone surveillance of a target, said process comprising the steps of:
releasing a flying autonomous drone in the vicinity of a surveillance target in range to surveil the target with an electronic payload carried by said drone;
transmitting information from said electronic payload via a drone antenna network to a ground station; and
landing said drone on a landing surface and stabilizing said drone in an immobile landing state by maintaining supportive surface contact with said antenna network.

18. The process of claim 17 wherein said landing step includes maintaining supportive surface contact with drone components consisting of said antenna network.

19. The process of claim 18 wherein said landing step includes maintaining supportive surface contact with drone components consisting of said antenna network and at least one inert artificial boom dimensioned similarly to an antenna of said antenna network.

20. The process of claim 17 further comprising the steps of (i) removing a primary removable hold, positioned on a lower portion of a drone fuselage, with a primary hold sidewall defining a cavity bearing a primary electronic payload entity, sized to be positioned within said primary hold cavity, having a primary entity communication port adapted to be in signaled transmission with said antenna complex comprising a primary antenna set as affixed to said hold sidewall, and (ii) replacing said primary removable hold with a secondary removable hold, bearing a secondary electronic payload entity, sized similar to said primary electronic payload entity, and with a secondary hold sidewall defining a cavity bearing a secondary electronic payload entity, sized to be positioned within said secondary hold cavity having a second entity communication port adapted to be in signaled transmission with an antenna complex comprising a secondary antenna set, operating at a different spectrum from said primary antenna set, affixed to secondary removable hold sidewall; and (iii) transmitting information from said secondary electronic payload via said drone antenna network to said ground station.
